(19) United States
(12) Patent Application Publication
(10) Pub. No.: US 2024/0293693 A1
(43) Pub. Date: Sep. 5, 2024

(54) STORING AND DISCHARGING DRY CHEMICAL FIRE EXTINGUISHING AGENTS

(71) Applicant: Kidde Technologies, Inc., Wilson, NC (US)

(72) Inventor: Eli Baldwin, Knightdale, NC (US)

(73) Assignee: Kidde Technologies, Inc., Wilson, NC (US)

(21) Appl. No.: 18/116,549

(22) Filed: Mar. 2, 2023

(51) Int. Cl. A62C 99/00; A62C 37/12

(52) U.S. Cl. CPC A62C 99/0027; A62C 37/12

(57) ABSTRACT

A system includes a pressure vessel defining an interior space with a discharge outlet. A valve or burst disc is connected in fluid communication with the discharge outlet. Discharge piping is included in fluid communication with the valve or burst disc to receive discharge from the interior space. One or more discharge nozzles are in fluid commination with discharge piping for issuing a spray from the discharge piping into the environment external of the pressure vessel. A mixture of liquid Carbon Dioxide (CO₂) and a dry chemical fire extinguishing agent is housed under pressure within the interior space.

### BACKGROUND

### 1. Field

The present disclosure relates to fire extinguishing, and more particularly to dry agents for fire extinguishing.

### 2. Description of Related Art

The conventional engine nacelle fire extinguishing agent was traditionally a gas (Halon 1301). It is, however, and ozone depleting gas and thus there is a need to find alternatives. Dry chemical agents are one possible alternative.

Achieving an efficient and robust dispersion of dry chemical fire extinguishing agent throughout the designated fire zones (DFZs) in aircraft engine nacelles and auxiliary power units (APUs) can be challenging. Dry chemical agents are generally stored with compressed gas in a bottle. A piping system connects the bottle to the DFZ. Upon discharge of the bottle, the compressed gas expands and carries the agent through the piping system and sprays it into the DFZ. The agent then aerosolizes and disperses throughout the DFZ. Unlike gaseous agents, dry chemical agents tend to adhere to surfaces. This tendency to lose agent to surfaces is exacerbated by the fact that many modern DFZs are highly cluttered. Thus, efficiently delivering adequate concentrations of airborne agent to every region of the DFZ is challenging.

The conventional techniques have been considered satisfactory for their intended purpose. However, there is an ever present need for improved systems and methods for storing and discharging dry chemical fire extinguishing agents. This disclosure provides a solution for this need.

### SUMMARY

A system includes a pressure vessel defining an interior space with a discharge outlet for fluid communication from the interior space to an environment external of the pressure vessel. A valve or burst disc is connected in fluid communication with the discharge outlet. The valve or burst disc is configured to block flow through the discharge outlet in a first state of the valve or burst disc, and to allow flow out of the discharge outlet in a second state of the valve or burst disc. Discharge piping is included in fluid communication with the valve or burst disc to receive discharge from the interior space with the valve or burst disc in the second state. One or more discharge nozzles are in fluid commination with discharge piping for issuing a spray from the discharge piping into the environment external of the pressure vessel with the valve or burst disc in the second state. A mixture of liquid Carbon Dioxide (CO₂) and a dry chemical fire extinguishing agent is housed under pressure within the interior space with the valve or burst disc in the first position.

The dry chemical fire extinguishing agent can include Sodium Bicarbonate (NaHCO₃) particles. The particles can be sized in a size range from 0.1 micron to 50 microns, inclusive of endpoints. The liquid CO₂ can fill into interstitial spaces between the particles. The NaHCO₃ particles can include additives. The dry chemical fire extinguishing agent can include potassium bicarbonate (PKP).

A method of fire extinguishing includes discharging a pressure vessel housing a mixture of liquid Carbon Dioxide (CO₂) and a dry chemical fire extinguishing agent through one or more nozzles. The method includes freezing a coating of the liquid CO₂ around particles of the dry chemical fire extinguishing agent by cooling from passage of the mixture through the one or more nozzles so that the particles are coated in dry ice. The method includes extinguishing a flame with the particles coated in dry ice.

Discharging the pressure vessel can include bouncing the particles coated in dry ice off of surfaces downstream of the one or more nozzles. Discharging the pressure vessel can include maintaining pressure in any lines feeding the one or more nozzles during discharge so CO₂ in the line or lines remains in liquid state while discharging the pressure vessel.

The method can include sublimating the dry ice off from the particles coated in dry ice. The method can include filling an aircraft compartment with a mixture of CO₂ gas sublimated from the particles coated in dry ice and with the particles of the dry chemical fire extinguishing agent after the CO₂ has sublimated off of the particles coated in dry ice.

Extinguishing the flame can include depriving the flame of Oxygen with the mixture of CO₂ gas and particles of dry chemical fire extinguishing agent in the aircraft compartment. Extinguishing the flame can include lowering heat in the aircraft compartment by absorbing heat into the mixture of CO₂ gas and particles of dry chemical fire extinguishing agent in the aircraft compartment. Extinguishing the flame can include lowering heat in the aircraft compartment by breaking down the particles of dry chemical fire extinguishing agent in endothermic reactions. Extinguishing the flame can include catalytic radical scavenging that chemically inhibits the combustion.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic view of an embodiment of a system constructed in accordance with the present disclosure, showing the pressure vessel housing a mixture of liquid carbon dioxide and dry chemical fire extinguishing agent particles or crystals;

FIG. 2 is a schematic view of one of the particles of FIG. 1, showing the particle coated in dry ice after passing through one of the nozzles;

FIG. 3 is a schematic view of the particle of FIG. 2 after the dry ice sublimates into carbon dioxide gas, exposing the dry chemical particle;

FIG. 4 is a schematic view of the system of FIG. 1 connected to an aircraft compartment, e.g. a designated fire zone (DFZ), with a fire inside, showing the dry ice coated particles bouncing off of surfaces proximate the nozzles; and

FIG. 5 is a schematic view of the system of FIG. 4, showing the aircraft compartment filled with a mixture of gaseous carbon dioxide and aerosolized dry chemical particles to extinguish the fire.

### DETAILED DESCRIPTION OF THE PREFERRED EMBODIMENTS

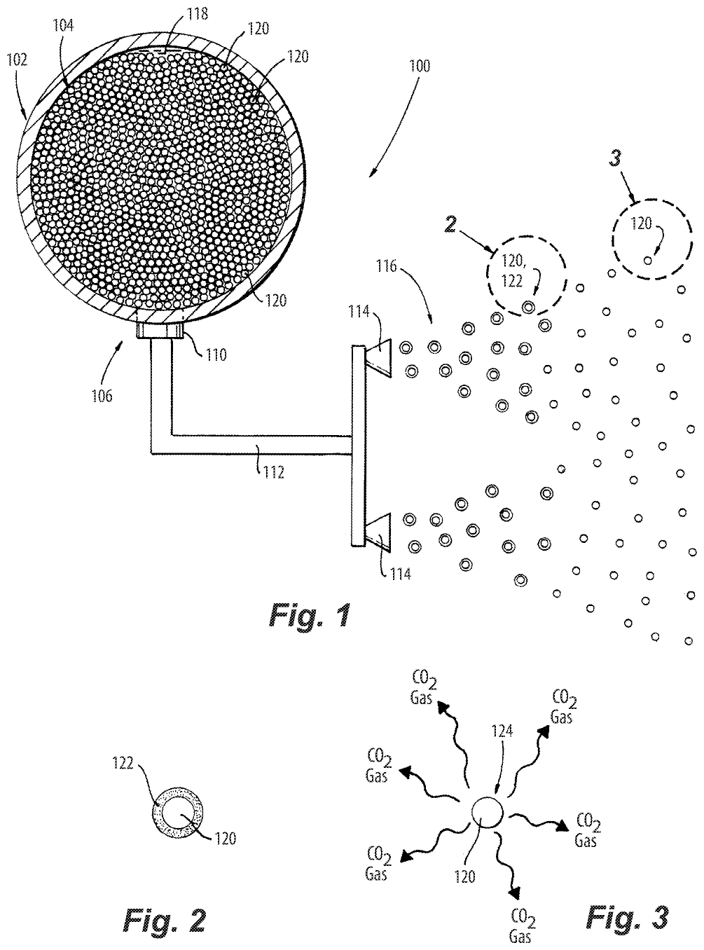

Reference will now be made to the drawings wherein like reference numerals identify similar structural features or aspects of the subject disclosure. For purposes of explanation and illustration, and not limitation, a partial view of an embodiment of a system in accordance with the disclosure is shown in FIG. 1 and is designated generally by reference character 100. Other embodiments of systems in accordance with the disclosure, or aspects thereof, are provided in FIGS. 2-5, as will be described. The systems and methods described herein can be used to store and discharge dry chemical fire extinguishing agents, e.g. for use in extinguishing fires onboard aircraft.

The system 100 includes a pressure vessel 102 defining an interior space 104 with a discharge outlet 106 for fluid communication from the interior space 104 to an environment 108 external of the pressure vessel 102. A discharge control device such as a valve or burst disc 110 is connected in fluid communication with the discharge outlet 106. The valve or burst disc 110 is configured to block flow through the discharge outlet 106 in a first state of the valve or burst disc, e.g. when there is no fire to maintain the contents of the interior space 104 under pressure. The valve or burst disc 110 is also configured to allow flow out of the discharge outlet 106 in a second state, i.e. upon detection of a fire needing to be extinguished. The discharge is actuated by opening the valve or burst disc 110 upon receipt of a discharge signal, e.g. from the cockpit, upon detection of a fire, or discharge can be actuated automatically. Discharge piping 112 is included in fluid communication with the valve or burst disc 110 to receive discharge from the interior space 104 when the valve or burst disc 110 is in the second state for extinguishing a fire. One or more discharge nozzles 114 are in fluid commination with discharge piping 112 for issuing a spray 116 from the discharge piping 112 into the environment 108 external of the pressure vessel 102 when the valve or burst disc released the pressure of the vessel 102 for extinguishing a fire. A mixture of liquid Carbon Dioxide (CO₂) 118 and a dry chemical fire extinguishing agent particles 120 or crystals is housed under pressure within the interior space 104 when the valve or burst disc is in its closed, normal position. Technically the CO₂ will be a two-phase fluid within the pressure vessel 102, with most of it being in the liquid phase. If the pressure vessel 102 gets hot enough during flight the CO₂ might become a supercritical fluid.

The dry chemical fire extinguishing agent includes particles 120 of Sodium Bicarbonate (NaHCO₃) particles, potassium bicarbonate (PKP), and/or particles of any other suitable dry chemical fire extinguishing agent plus any applicable additives. The particles 120 are sized in a size range from 0.1 micron to 50 microns, inclusive of endpoints. The liquid CO₂ 118 inside the interior space 104 fills into interstitial spaces between the particles 120, e.g. 70% of tank volume is available for liquid CO₂ storage in close-packed interstices of the particles 120. To reach the liquid state, the interior space 104 can be filled with CO₂ to a pressure about 800 psi (54.43 atm) or more. Depending on the required low temperature operating range, an additional pressurizing gas like N2, He, or Argon, may be added in small quantities to the extinguisher to ensure sufficient discharge pressure.

With continued reference to FIG. 1, a method of fire extinguishing includes discharging the pressure vessel 102 through the one or more nozzles 114, e.g. by opening the valve or burst disc in response to detecting a fire. As the mixture of liquid CO₂ and particles 120 pass through metering orifices of the nozzles 114, the mixture passing through the nozzles 114 cools significantly. During discharge, the liquid CO₂ expands and evaporates thus dropping the fluid temperature to the triple point. At this point the CO₂ begins to freeze and makes a coating 122 dry ice frozen from the liquid CO₂ around the particles 120 of the dry chemical fire extinguishing agent. As shown in FIGS. 1 and 2, the particles 120 near the nozzles 114 are coated in a coating 122 of dry ice. As the coated particles 120 travel further from the nozzles 114, the dry ice coating 122 sublimates way from the particles 120, as indicated in FIGS. 1 and 3, becoming CO₂ gas 124.

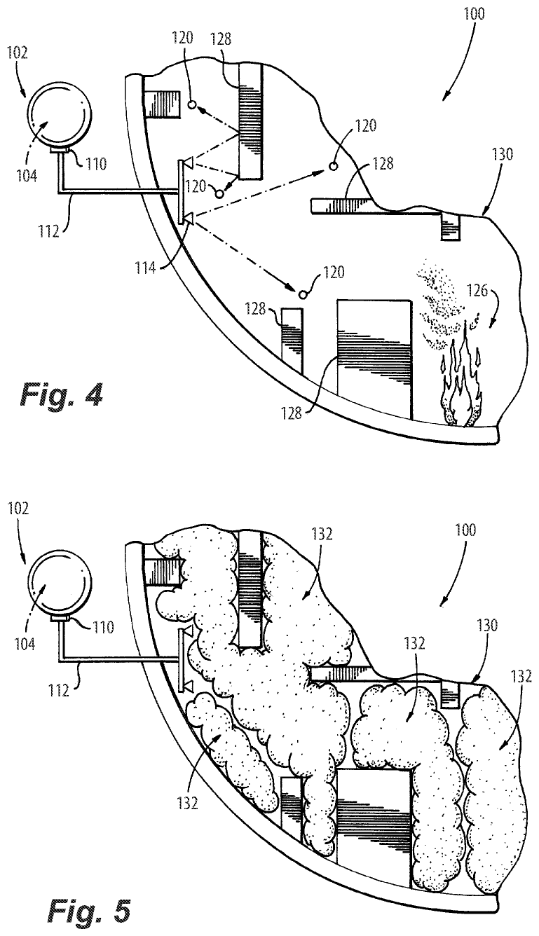

With reference now to FIG. 4, the method includes extinguishing a flame 126 with the particles 120 coated in dry ice. While the particles 120 are still coated with dry ice (as shown in FIG. 2) they coated particles 120 bounce off of surfaces 128 downstream of the one or more nozzles 114, as indicated in FIG. 4 with the trajectory arrows. Discharging the pressure vessel 102 includes maintaining pressure in the line or lines 112 feeding the one or more nozzles 114 during discharge so CO₂ in the line or lines 112 remains in a pressurized two-phase state while discharging the pressure vessel 102.

After the dry ice coated particles 120 (as shown in FIGS. 1-3) have traveled some distance from the nozzles 114, and have persisted for some time, the dry ice coating 122 sublimates off from the particles 122 of dry chemical fire extinguishing agent (as shown in FIG. 3). The method includes filling an aircraft compartment 130, e.g. a designated fire zone (DFZ), with a mixture of CO₂ gas sublimated from the particles 120, and with the aerosolized particles 120 of the dry chemical fire extinguishing agent after, i.e. distributing the gaseous CO₂ and particles 120 substantially evenly within the compartment 130 as indicated schematically in FIG. 5 by the clouds representing the mixture 132 of CO₂ gas and aerosolized particles of dry chemical fire extinguishing agent in FIG. 5.

This extinguishes the flame 126 of FIG. 4 by depriving the flame of Oxygen with the mixture of CO₂ gas and particles of dry chemical fire extinguishing agent in the aircraft compartment, i.e. the expansion of the mixture 132 into the compartment 130 displaces air out of the compartment 130. This also extinguishes the flame 126 by lowering heat in the aircraft compartment 130 by absorbing heat into the mixture 132, as well as by breaking down the particles 120 (labeled in FIGS. 2-3) of dry chemical fire extinguishing agent in endothermic reactions. These constituents can also chemically combat the flame 126 (labeled in FIG. 4) via catalytic radical scavenging.

Systems and methods as disclosed herein provide various potential benefits including a more efficient distribution of the dry-chemical agent than in previous methods as a result of the following. The solid CO₂ can physically shield the dry-chemical agent from contacting surfaces upon impact (to reduce coating the surfaces). The tendency is reduced for particles to impact surfaces due to the sublimating dry ice coating providing a gas cushion to the dry-chemical agent. Dispersion and diffusion of the agent due can be improved to the expanding carbon dioxide displacing more ambient air than the equivalent system charged with compressed gas (N₂, He, or Argon). Dispersion and diffusion of the agent can also be improved due to the transient nature of the sublimation and resulting expansion of the carbon dioxide, e.g. as opposed to standard compressed gas driven systems that are fully expanded at or shortly after the nozzle exit.

The methods and systems of the present disclosure, as described above and shown in the drawings, provide for storage and discharge of dry chemical fire extinguishing agents, e.g. for use in extinguishing fires onboard aircraft. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A system comprising:
a pressure vessel defining an interior space with a discharge outlet for fluid communication from the interior space to an environment external of the pressure vessel;
a valve or burst disc connected in fluid communication with the discharge outlet, wherein in the valve or burst disc is configured to block flow through the discharge outlet in a first state of the valve or burst disc, and to allow flow out of the discharge outlet in a second state of the valve or burst disc;
discharge piping in fluid communication with the valve or burst disc to receive discharge from the interior space with the valve or burst disc in the second state;
one or more discharge nozzles in fluid commination with discharge piping for issuing a spray from the discharge piping into the environment external of the pressure vessel with the valve or burst disc in the second state; and
a mixture of liquid Carbon Dioxide (CO₂) and a dry chemical fire extinguishing agent housed under pressure within the interior space with the valve or burst disc in the first position.

2. The system as recited in claim 1, wherein the dry chemical fire extinguishing agent includes Sodium Bicarbonate (NaHCO₃) particles.

3. The system as recited in claim 2, wherein the particles are sized in a size range from 0.1 micron to 50 microns, inclusive of endpoints.

4. The system as recited in claim 2, wherein the liquid CO₂ fills into interstitial spaces between the particles.

5. The system as recited in claim 2, wherein the NaHCO₃ particles include additives.

6. The system as recited in claim 1, wherein the dry chemical fire extinguishing agent includes potassium bicarbonate (PKP).

7. A method of fire extinguishing comprising:
discharging a pressure vessel housing a mixture of liquid Carbon Dioxide (CO₂) and a dry chemical fire extinguishing agent through one or more nozzles;
freezing a coating of the liquid CO₂ around particles of the dry chemical fire extinguishing agent by cooling from passage of the mixture through the one or more nozzles so that the particles are coated in dry ice; and
extinguishing a flame with the particles coated in dry ice.

8. The method as recited in claim 7, wherein discharging the pressure vessel includes bouncing the particles coated in dry ice off of surfaces downstream of the one or more nozzles.

9. The method as recited in claim 8, further comprising sublimating the dry ice off from the particles coated in dry ice.

10. The method as recited in claim 9, further comprising filling an aircraft compartment with a mixture of CO₂ gas sublimated from the particles coated in dry ice and with the particles of the dry chemical fire extinguishing agent after the CO₂ has sublimated off of the particles coated in dry ice.

11. The method as recited in claim 10, wherein extinguishing the flame includes depriving the flame of Oxygen with the mixture of CO₂ gas and particles of dry chemical fire extinguishing agent in the aircraft compartment.

12. The method as recited in claim 10, wherein extinguishing the flame includes lowering heat in the aircraft compartment by absorbing heat into the mixture of CO₂ gas and particles of dry chemical fire extinguishing agent in the aircraft compartment.

13. The method as recited in claim 12, wherein extinguishing the flame includes lowering heat in the aircraft compartment by breaking down the particles of dry chemical fire extinguishing agent in endothermic reactions.

14. The method as recited in claim 13, wherein extinguishing the flame includes catalytic radical scavenging that chemically inhibits the combustion.

15. The method as recited in claim 1, wherein discharging the pressure vessel includes maintaining pressure in any lines feeding the one or more nozzles during discharge so CO₂ in the line or lines remains in liquid state while discharging the pressure vessel.
